(19) United States
(12) Patent Application Publication
(10) Pub. No.: US 2025/0200949 A1
(43) Pub. Date: Jun. 19, 2025

(54) TRAINING DEVICE, TRAINING SYSTEM, MEDIUM, AND INFORMATION PROCESSING METHOD FOR TRAINING DEVICE

(71) Applicant: Mitsubishi Electric Corporation, Tokyo (JP)

(72) Inventors: Takuya MATSUDA, Tokyo (JP); Naohiro SHIBUYA, Tokyo (JP); Yoshimi MORIYA, Tokyo (JP); Akira MINEZAWA, Tokyo (JP)

(73) Assignee: Mitsubishi Electric Corporation, Tokyo (JP)

(21) Appl. No.: 19/067,277

(22) Filed: Feb. 28, 2025

Related U.S. Application Data
(63) Continuation of application No. PCT/JP2022/033335, filed on Sep. 6, 2022.

(51) Int. Cl. G06V 10/774; G06V 10/74; G06V 10/776

(52) U.S. Cl. CPC G06V 10/774; G06V 10/761; G06V 10/776

(57) ABSTRACT

A training device includes: a training image acquiring unit that acquires a training image; a feature extracting unit that calculates a shared feature space feature of the training image; an existing feature acquiring unit that acquires a pre-stored trained model and an existing feature corresponding to the pre-stored trained model; a feature comparing unit that calculates a similarity between the shared feature space feature and the existing feature as an index; a model selecting unit that selects, as a base model, one of the trained models suitable for a purpose of training, on the basis of the index; a model training unit that performs retraining for the base model; a model evaluating unit that evaluates inference performance of the retrained base model; and a trained model outputting unit that outputs the retrained base model.

### CROSS REFERENCE TO RELATED APPLICATIONS

This application is a Continuation of PCT International Application No. PCT/JP2022/033335 filed on Sep. 6, 2022, all of which is hereby expressly incorporated by reference into the present application.

### TECHNICAL FIELD

The present disclosed technique relates to a training device, a training system, a medium, and an information processing method for the training device.

### BACKGROUND ART

In the technical field of machine learning, a method for increasing development efficiency by successfully using an existing training model instead of full scratch is known.

For example, Patent Literature 1 describes an information processing device that adopts a method for selecting, from among a plurality of models, a model that is trained with data corresponding to an attribute of a recognition target and has good recognition performance for the recognition target. According to Patent Literature 1, for example, in training of a model that recognizes a crack, an attribute of data is exemplified as “a type of an infrastructure structure such as a bridge or a tunnel”.

The attribute of data assumed in Patent Literature 1 is defined by a human who is a user, and is based on a human concept such as “bridge”, “tunnel”, or “dam”.

### CITATION LIST

### Patent Literature

Patent Literature 1: JP 2021-81793 A

### SUMMARY OF INVENTION

### Technical Problem

Although Patent Literature 1 focuses on the attribute of data, it is not possible to quantitatively indicate whether or not a training model is suitable for a purpose of training only by the attribute of data. For example, in a case where there are a training model a and a training model b trained with training data sets having the same data attribute as “bridge”, “tunnel”, and “dam” but having different images themselves, it cannot be known which training model should be used. In related art, in such a case, it is necessary to perform a recognition performance test of both the training model a and the training model b. This does not significantly increase development efficiency.

An object of the present disclosed technique is to provide a training device and a training system that introduce an index quantitatively indicating whether or not an existing training model is suitable for a purpose of training and have higher development efficiency than related art.

### Solution to Problem

A training device according to the present disclosed technique includes: processing circuitry configured to; acquire a plurality of training images; calculate a shared feature space feature for each of the plurality of training images; acquire a pre-stored trained model and an existing feature corresponding to the pre-stored trained model; calculate a similarity between the shared feature space feature and the existing feature as an index by using the shared feature space feature for each of the plurality of training images and using a distance in the shared feature space based on distribution of the shared feature space features plotted in the shared feature space and the existing feature; select, as a base model, one of the trained models suitable for a purpose of training, on the basis of the index; perform retraining for the base model; evaluate inference performance of the retrained base model; and output the retrained base model.

### Advantageous Effects of Invention

The training device according to the present disclosed technique has the above configuration, and therefore can quantitatively indicate whether or not an existing training model is suitable for a purpose of training, and has higher development efficiency than related art.

### BRIEF DESCRIPTION OF DRAWINGS

FIG. 1 is an explanatory diagram illustrating a configuration of a training system according to a first embodiment.

FIG. 2 is a block diagram illustrating a functional configuration of a training device according to the first embodiment.

FIG. 3A and FIG. 3B are explanatory diagrams illustrating a hardware configuration of the training device according to the first embodiment.

FIG. 4 is a flowchart illustrating processing steps of the training device according to the first embodiment.

### DESCRIPTION OF EMBODIMENTS

It can be said that a problem solved by a training system 1 according to the present disclosed technique is a certain type of optimization problem similarly to a general machine learning problem. Regarding the optimization problem, a no-free lunch theorem is known. What the no-free lunch theorem is referring to is that, briefly, a model with both high versatility and high performance is theoretically impossible. One model (M-A) performs better than another model (M-B) because the model (M-A) is technicalized or specialized for a specific problem to be solved.

It can be said that a feature of the present disclosed technique is that a model trained in a wide range in a general-purpose manner and a model trained in a specific range in a specialized manner are selectively used with ingenuity.

### First Embodiment

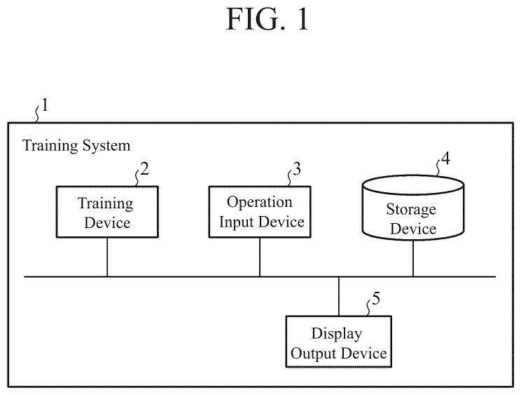

FIG. 1 is an explanatory diagram illustrating a configuration of a training system 1 according to a first embodiment. As illustrated in FIG. 1, the training system 1 according to the first embodiment includes a training device 2, an operation input device 3, a storage device 4, and a display output device 5.

As illustrated in FIG. 1, the training device 2, the operation input device 3, the storage device 4, and the display output device 5 may be connected to each other by an information network such as a local area network (LAN).

### <<Training Device 2 Constituting Training System 1>>

The training device 2 constituting the training system 1 is a device including a mathematical model (also referred to as a “training model”) capable of supervised training on the basis of a training data set including a training image or the like.

Details of the training device 2 will be apparent from the following description.

### <<Operation Input Device 3 Constituting Training System 1>>

The operation input device 3 constituting the training system 1 is a user interface that receives a user's operation (hereinafter, simply referred to as “user operation”) and outputs a corresponding operation signal. Specifically, the operation input device 3 is a device such as a keyboard, a pointing device, a touch panel, or a touch sensor.

The operation signal output from the operation input device 3 is transmitted to the training device 2.

### <<Storage Device 4 Constituting Training System 1>>

The storage device 4 constituting the training system 1 is a device that stores information necessary for processing performed by the training device 2. As illustrated in FIG. 1, the storage device 4 is disposed outside the training device 2. A memory 7 described later is disposed inside the training device 2, and in the present specification, the memory 7 and the storage device 4 are distinguished from each other.

As illustrated in FIG. 1, the storage device 4 can be accessed from the training device 2. Therefore, the training device 2 can read information stored in the storage device 4 and can store information in the storage device 4.

### <<Display Output Device 5 Constituting Training System 1>>

The display output device 5 constituting the training system 1 is a user interface that gives visual information to a user. The display output device 5 is, for example, a display. The visual information given to a user is transmitted from the training device 2.

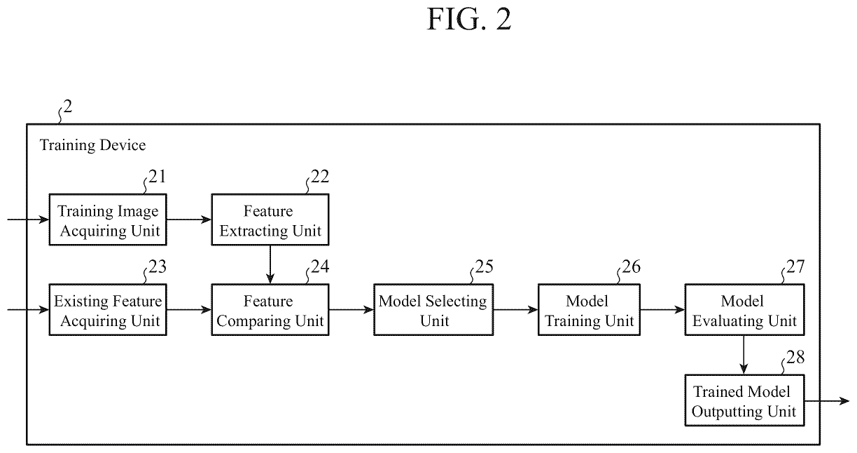

FIG. 2 is a block diagram illustrating a functional configuration of the training device 2 according to the first embodiment. As illustrated in FIG. 2, the training device 2 includes a training image acquiring unit 21, a feature extracting unit 22, an existing feature acquiring unit 23, a feature comparing unit 24, a model selecting unit 25, a model training unit 26, a model evaluating unit 27, and a trained model outputting unit 28.

### <<Training Image Acquiring Unit 21 in Training Device 2>>

The training image acquiring unit 21 in the training device 2 is a component that acquires a training data set, for example, a training image.

There is generally a plurality of training images. It is assumed that the training image is stored in the storage device 4, for example. The training image acquiring unit 21 acquires the training image stored in the storage device 4.

The training image acquired by the training image acquiring unit 21 is transmitted to the feature extracting unit 22.

### <<Feature Extracting Unit 22 in Training Device 2>>

The feature extracting unit 22 in the training device 2 is a component that extracts a feature from the transmitted training image. Here, the feature is a term generally used in the technical field of machine learning, and in short, is numerical data expressing a feature such as a thing or an event. More strictly, the feature is a characteristic or an attribute of data that can be used by a model to perform prediction.

A role of the feature extracting unit 22 is to function as an AI device that has been subjected to preliminary training in image recognition, that is, that has acquired in advance by training a method for converting target data into an expression in which a problem is easily solved. The expression method acquired by this expression training is the feature.

The feature extracted by the feature extracting unit 22 is referred to as a “shared feature space feature” in the present specification in order to be distinguished from a feature used as a common noun. The shared feature space feature can also be considered as a vector defined in the “shared feature space”. In general, when certain image data is input to a training device, a feature obtained as an intermediate product can vary depending on a training process (progress). On the other hand, the shared feature space feature defined by the present disclosed technique does not vary as an expression of certain image data.

The shared feature space is a wide area map such as a world map if a figurative expression is used. The world map is suitable for overlooking because the world map can include a wide range of information, but is not suitable for a purpose of examining detailed information. Details of how the shared feature space is used in the present disclosed technique will be apparent from the following description.

The feature extracting unit 22 includes a mathematical model for extracting a shared feature space feature. Examples of a well-known mathematical model include an artificial neural network (also referred to simply as a “neural network”).

In the training device 2 according to the present disclosed technique, the mathematical model included in the feature extracting unit 22 is preferably ResNet trained by ImageNet that is a general image data set. The following document serves as a reference for ResNet.

“Kaiming He, Xiangyu Zhang, Shaoqing Ren, Jian Sun”, “Deep Residual Learning for Image Recognition”, “Proceedings of the IEEE Conference on Computer Vision and Pattern Recognition (CVPR) 2016 pp. 770-778”.

In general, the feature includes a local feature to a global feature in an image. It is also considered that the local feature includes, for example, a characteristic related to an edge and a characteristic related to a partial shape. It is also conceivable that the global feature includes, for example, a characteristic specific to a category to which a teacher label belongs.

A training model that has been sufficiently trained (referred to as a “trained model”) extracts a feature appropriate for achieving a purpose of training. As described above, what the trained model extracts as a feature is necessary to achieve a purpose of training, and thus, does not necessarily coincide with a feature of an image considered by a human, for example, “having a texture like metal”, “having a triangular shape as a whole”, or “a dog appears”. This is because “metal”, “texture”, “triangle”, “dog”, and the like are concepts created by a human, and the mathematical model does not have these concepts. Artificial intelligence having the trained model is merely able to extract a feature appropriate for achieving a purpose of training through machine learning.

The feature extracting unit 22 may use a method called bag of visual words (BOW) in order to extract a shared feature space feature. BOW is a method for dimensionally compressing an image into a one-dimensional vector (also referred to as a “feature vector”). BOW may be referred to as bag of words or bag of features. The following document serves as a reference for BOW.

“Csurk, Gabriella, et al.”, “Visual categorization with bags of keypoints.”, Workshop on statistical learning in computer vision, ECCV. Vol. 1. No. 1-22. 2004.

As described above, a generally known training model may be used as the feature extracting unit 22. Recently, an application capable of performing search only by taking a picture or holding a camera is widespread, and the feature extracting unit 22 may apply a technique used in such an application. In addition, the feature extracting unit 22 may use a generally known feature extraction method.

Note that, as described above, since the shared feature space functions as a wide area map such as a world map, it is preferable to use a training model that has many classification classes and that has been subjected to preliminary training with a wide range of general images in order to have versatility. In addition, desirably, the shared feature space feature does not vary as an expression of certain image data. Therefore, the training model for the feature extracting unit 22 to extract the shared feature space feature does not proceed with training, and is used with a parameter fixed.

The shared feature space feature extracted by the feature extracting unit 22 is transmitted to the feature comparing unit 24 together with an original training image.

### <<Existing Feature Acquiring Unit 23 in Training Device 2>>

The existing feature acquiring unit 23 in the training device 2 is a component that acquires an “existing features” stored in advance in the storage device 4.

The training system 1 according to the present disclosed technique includes several types of trained models in advance in the storage device 4. These trained models are stored in the storage device 4 in advance as candidates for a training model selected depending on a purpose of training. In contrast to a training model widely trained for a general-purpose purpose included in the feature extracting unit 22, the trained model to be stored in the storage device 4 is a specialized trained model to be trained for a specific purpose. Although the trained model stored in the storage device 4 literally means a model that has already been trained, training is further performed (referred to as “retraining”) in the model training unit 26 described later. Details of the retraining will be apparent from the following description.

The training system 1 according to the present disclosed technique adds a certain index to the trained model to be stored in the storage device 4, and a base of the index is an existing feature.

For example, it is assumed that a trained model (M-P) to be stored in the storage device 4 has been trained while being specialized for image recognition of a plant flower. When image data is input to the trained model (M-P), the trained model (M-P) can also generate a feature as an intermediate product. A feature space in the trained model (M-P) is a detailed map only for a specific region if a figurative expression is used. The feature generated by the trained model (M-P) is an amount that makes sense only in a feature space defined only in the trained model (M-P), and cannot be used as an index to be compared with another model.

For example, it is assumed that the trained model (M-P) has been trained in such a manner that “spring flowers=>1, summer flowers=>2, autumn flowers=>3, and winter flowers=>4”. It is assumed that another trained model (M-V) has been trained while being specialized for a vertebrate, and has been trained in such a manner that “dog=>1, cat=>2, and others=>3”. In general, a feature vector obtained as an intermediate product in this manner is not uniform in terms of a meaning of an element thereof and a dimension thereof.

The present disclosed technique focuses on what type of training data set has been used for training of the trained model (M-P). Then, the present disclosed technique calculates a shared feature space feature for each of images used for training of the trained model (M-P). Here, the shared feature space feature is calculated in advance using a similar means to the feature extracting unit 22. A representative point of the shared feature space feature obtained here is stored in the storage device 4 as an existing feature. By calculating the shared feature space feature in this manner, the trained model (M-P) can be expressed as a model in which a shared feature space feature of an image used for training is plotted in the shared feature space. If a figurative expression is used, the trained model (M-P) can be expressed as a plot distributed in an area corresponding to “plant flower” in a shared feature space that is a world map.

The present disclosed technique adopts, for example, a representative point such as a center of gravity of a shared feature space feature plotted in a shared feature space as an existing feature for determining an index of the trained model (M-P). If a figurative expression is used, it can be said that the existing feature of the trained model (M-P) is a center of the “plant flower” area in the shared feature space that is a world map.

As the trained model stored in the storage device 4, in addition to the plant flower, an insect, a bird, an animal, a great person, a national flag, an art, and a model specialized for any other theme found in a picture book are conceivable. Furthermore, examples of the trained model stored in the storage device 4 include a model specialized for an unmanned register, a model specialized for character recognition such as optical character recognition (OCR), a model specialized for biometric authentication, a model specialized for three-dimensional shape recognition, a model specialized for robot control, a model specialized for automatic driving, a model specialized for crime prevention, and a model specialized for various other fields.

The candidate of the training model and the existing feature acquired by the existing feature acquiring unit 23 are transmitted to the feature comparing unit 24.

### <<Feature Comparing Unit 24 in Training Device 2>>

The feature comparing unit 24 in the training device 2 is a component for comparing a shared feature space feature in a shared feature space. More specifically, the content of processing performed by the feature comparing unit 24 is to calculate a distance between two or more shared feature space features (vectors) plotted in the shared feature space.

In other words, a fact that a distance between two shared feature space features in the shared feature space is short means that original two images have close characteristics or attributes.

A start point of a distance in the shared feature space calculated by the feature comparing unit 24 is the shared feature space feature extracted by the feature extracting unit 22. An end point of the distance calculated by the feature comparing unit 24 is a plurality of existing features corresponding to the plurality of trained models acquired by the existing feature acquiring unit 23, respectively.

As described above, since a plurality of training images may be input to the training image acquiring unit 21, the shared feature space feature related to the training image plotted in the shared feature space is distributed. Therefore, the feature comparing unit 24 may use a Mahalanobis distance often used in statistics as the distance in the shared feature space.

The essence of the processing performed by the feature comparing unit 24 is to search for a trained model trained by image data having close characteristics or attributes from an input training image. The value calculated by the feature comparing unit 24 is not limited to a “distance” such as a Euclidean distance or the Mahalanobis distance from such a viewpoint. The feature comparing unit 24 may calculate a value using a concept of a similarity such as a cosine similarity.

The value (distance, similarity, or the like) calculated by the feature comparing unit 24 for each trained model is transmitted to the model selecting unit 25 as an index for selecting a trained model suitable for a purpose of training.

### <<Model Selecting Unit 25 in Training Device 2>>

The model selecting unit 25 in the training device 2 is a component that directly selects one trained model determined to be most suitable for a purpose of training or proposes a candidate of a trained model to be selected to a user on the basis of the index transmitted from the feature comparing unit 24.

In a case where determination of a user is not necessary, specifically, the model selecting unit 25 directly selects a trained model having the closest distance in the shared feature space or the highest similarity on the basis of the index transmitted from the feature comparing unit 24.

In a case where the trained model to be used is determined by determination of a user, the model selecting unit 25 lists trained models, for example, in an ascending order of a distance in the shared feature space or in a descending order of a similarity, and displays the listed trained models on the display output device 5. The user answers the trained model to be used with the operation input device 3 from the list displayed on the display output device 5.

The trained model directly or indirectly selected by the model selecting unit 25 is transmitted to the model training unit 26 as a base model.

### <<Model Training Unit 26 in Training Device 2>>

The model training unit 26 in the training device 2 is a component that performs retraining for the base model selected by the model selecting unit 25. The training data set for the model training unit 26 to perform retraining for the base model may be a training image acquired via the training image acquiring unit 21.

As described above, the training image for calculating the shared feature space feature in the feature extracting unit 22 may be one or a plurality of training images acquired via the training image acquiring unit 21. On the other hand, the model training unit 26 uses, in principle, all the training images except for a training image left for evaluation among the training images acquired via the training image acquiring unit 21 for retraining.

The retrained base model and the training image left for evaluation are transmitted to the model evaluating unit 27.

### <<Model Evaluating Unit 27 in Training Device 2>>

The model evaluating unit 27 in the training device 2 is a component that evaluates inference performance of the retrained base model using the training image left for evaluation.

An evaluation result performed by the model evaluating unit 27 is preferably displayed on the display output device 5 in order to notify the user of the evaluation result. Note that the training system 1 according to the present disclosed technique may be configured to display training performance evaluation on the display output device 5 together with the inference performance evaluation.

The user determines whether to complete the retraining or to continue the retraining by adding a training data set on the basis of the evaluation result displayed on the display output device 5.

In a case where it is determined that the retraining is completed, the retrained base model is transmitted to the trained model outputting unit 28.

### <<Trained Model Outputting Unit 28 in Training Device 2>>

The trained model outputting unit 28 in the training device 2 is a component that stores the retrained base model in the storage device 4.

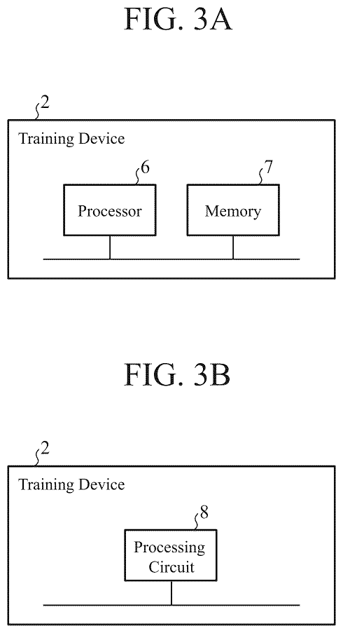

FIG. 3 is an explanatory diagram illustrating a hardware configuration of the training device 2 according to the first embodiment.

In the training device 2 according to the first embodiment, functions of the training image acquiring unit 21, the feature extracting unit 22, the existing feature acquiring unit 23, the feature comparing unit 24, the model selecting unit 25, the model training unit 26, the model evaluating unit 27, and the trained model outputting unit 28 are implemented by a processing circuit. The processing circuit may be either a processor 6 that executes a program stored in the memory 7 (see FIG. 3A) or a processing circuit 8 that is dedicated hardware (see FIG. 3B).

FIG. 3A is a hardware configuration diagram in a case where the functions of the training device 2 are executed by software. In the case of a hardware configuration illustrated in FIG. 3A, the functions of the training device 2 are implemented by software, firmware, or a combination of software and firmware. The software and the firmware are each described as a program and stored in the memory 7. By reading and executing a program stored in the memory 7, the processor 6 (also referred to as a CPU, a central processing device, a processing device, a microprocessor, a microcomputer, or a DSP) implements the function of each unit. That is, the training device 2 includes the memory 7 for storing a program that causes the functions of the training device 2 to be executed as a result when the program is executed by the processor 6. In addition, it can also be said that these programs cause the processor 6 to execute a procedure or a method performed by the training device 2. Here, the memory 7 may be a nonvolatile or volatile semiconductor memory such as a RAM, a ROM, a flash memory, or an EPROM. In addition, the memory 7 may include a disk such as a magnetic disk, a flexible disk, an optical disk, a compact disk, a mini disk, or a DVD. Furthermore, the memory 7 may be in a form of an HDD or an SSD.

FIG. 3B is a hardware configuration diagram in a case where the functions of the training device 2 are executed by dedicated hardware. In a case of a hardware configuration illustrated in FIG. 3B, for example, a single circuit, a composite circuit, a programmed processor, a parallel programmed processor, an ASIC, an FPGA, or a combination thereof corresponds to the processing circuit 8. The functions of the training device 2 may be implemented by individual processing circuits 8, respectively, or may be collectively implemented by one processing circuit 8.

Note that some of the functions of the training device 2 may be implemented by software or firmware, and the remaining functions may be implemented by dedicated hardware. In this manner, the training device 2 can implement the functions by hardware, software, firmware, or a combination thereof.

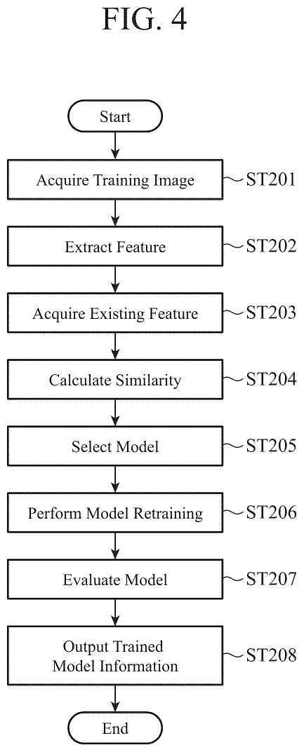

FIG. 4 is a flowchart illustrating processing steps of the training device 2 according to the first embodiment. As illustrated in FIG. 4, the processing steps of the training device 2 according to the first embodiment include a processing step of acquiring a training image (ST201), a processing step of extracting a feature (ST202), a processing step of acquiring an existing feature (ST203), a processing step of calculating a similarity (ST204), a processing step of selecting a model (ST205), a processing step of performing model retraining (ST206), a processing step of evaluating a model (ST207), and a processing step of outputting trained model information (ST208).

The processing step of acquiring a training image (ST201) is a processing step performed by the training image acquiring unit 21.

The processing step of extracting a feature (ST202) is a processing step performed by the feature extracting unit 22.

The processing step of acquiring an existing feature (ST203) is a processing step performed by the existing feature acquiring unit 23.

The processing step of calculating a similarity (ST204) is a processing step performed by the feature comparing unit 24.

The processing step of selecting a model (ST205) is a processing step performed by the model selecting unit 25.

The processing step of performing model retraining (ST206) is a processing step performed by the model training unit 26.

The processing step of evaluating a model (ST207) is a processing step performed by the model evaluating unit 27.

The processing step of outputting trained model information (ST208) is a processing step performed by the trained model outputting unit 28.

One of excellent effects of the training system 1 according to the present disclosed technique is that a model trained in a wide range in a general-purpose manner and a model trained in a specific range in a specialized manner are selectively used.

One of excellent effects of the training system 1 according to the present disclosed technique is that an index (distance or similarity) quantitatively indicating whether or not an existing training model is suitable for a purpose of training can be proposed by definition of a shared feature space.

One of excellent effects of the training system 1 according to the present disclosed technique is that the number of times of execution of an unnecessary recognition performance test is reduced and development efficiency is improved as compared with related art.

### INDUSTRIAL APPLICABILITY

The training system 1 and the training device 2 according to the present disclosed technique can be widely applied to a technical field of image recognition, and have industrial applicability.

### REFERENCE SIGNS LIST

1: training system, 2: training device, 3: operation input device, 4: storage device, 5: display output device, 6: processor, 7: memory, 8: processing circuit, 21: training image acquiring unit, 22: feature extracting unit, 23: existing feature acquiring unit, 24: feature comparing unit, 25: model selecting unit, 26: model training unit, 27: model evaluating unit, 28: trained model outputting unit

1. A training device comprising:
processing circuitry configured to
acquire a plurality of training images;
calculate a shared feature space feature for each of the plurality of training images;
acquire a pre-stored trained model and an existing feature corresponding to the pre-stored trained model;
calculate a similarity between the shared feature space feature and the existing feature as an index by using the shared feature space feature for each of the plurality of training images and using a distance in the shared feature space based on distribution of the shared feature space features plotted in the shared feature space and the existing feature;
select, as a base model, one of the trained models suitable for a purpose of training, on a basis of the index;
perform retraining for the base model;
evaluate inference performance of the retrained base model; and
output the retrained base model.

2. A training system comprising a training device, an operation input device, a storage device, and a display output device connected to each other, wherein
the training device includes:
processing circuitry configured to
acquire a plurality of training images;
calculate a shared feature space feature for each of the plurality of training images;
acquire a pre-stored trained model and an existing feature corresponding to the pre-stored trained model;
calculate a similarity between the shared feature space feature and the existing feature as an index by using the shared feature space feature for each of the plurality of training images and using a distance in the shared feature space based on distribution of the shared feature space features plotted in the shared feature space and the existing feature;
select, as a base model, one of the trained models suitable for a purpose of training, on a basis of the index;
perform retraining for the base model;
evaluate inference performance of the retrained base model; and
output the retrained base model.

3. A non-transitory computer readable medium with an executable program stored thereon, wherein the program instructs a computer to perform:
acquiring a plurality of training images;
calculating a shared feature space feature for each of the plurality of training images;
acquiring a pre-stored trained model and an existing feature corresponding to the pre-stored trained model;
calculating a similarity between the shared feature space feature and the existing feature as an index by using the shared feature space feature for each of the plurality of training images and using a distance in the shared feature space based on distribution of the shared feature space features plotted in the shared feature space and the existing feature;
selecting, as a base model, one of the trained models suitable for a purpose of training, on a basis of the index;
performing retraining for the base model;
evaluating inference performance of the retrained base model; and
outputting the retrained base model.

4. An information processing method for a training device, comprising:
acquiring a plurality of training images;
calculating a shared feature space feature for each of the plurality of training images;
acquiring a pre-stored trained model and an existing feature corresponding to the pre-stored trained model;
calculating a similarity between the shared feature space feature and the existing feature as an index by using the shared feature space feature for each of the plurality of training images and using a distance in the shared feature space based on distribution of the shared feature space features plotted in the shared feature space and the existing feature;
selecting, as a base model, one of the trained models suitable for a purpose of training, on a basis of the index;
performing retraining for the base model;
evaluating inference performance of the retrained base model; and
outputting the retrained base model.

5. A training device comprising:
processing circuitry configured to
acquire a plurality of training images;
calculate a shared feature space feature for each of the plurality of training images;
acquire a pre-stored trained model and an existing feature corresponding to the pre-stored trained model;
calculate a similarity between the shared feature space feature and the existing feature as an index by using the shared feature space feature for each of the plurality of training images and using a distance in the shared feature space based on distribution of the shared feature space features plotted in the shared feature space and the existing feature;
select, as a base model, one of the trained models suitable for a purpose of training, on a basis of the index; and
perform retraining for the base model.

6. A non-transitory computer readable medium with an executable program stored thereon, wherein the program instructs a computer to perform:
acquiring a plurality of training images;
calculating a shared feature space feature for each of the plurality of training images;
acquiring a pre-stored trained model and an existing feature corresponding to the pre-stored trained model;
calculating a similarity between the shared feature space feature and the existing feature as an index by using the shared feature space feature for each of the plurality of training images and using a distance in the shared feature space based on distribution of the shared feature space features plotted in the shared feature space and the existing feature;
selecting, as a base model, one of the trained models suitable for a purpose of training, on a basis of the index;
performing retraining for the base model.

7. An information processing method for a training device, comprising:
acquiring a plurality of training images;
calculating a shared feature space feature for each of the plurality of training images;
acquiring a pre-stored trained model and an existing feature corresponding to the pre-stored trained model;
calculating a similarity between the shared feature space feature and the existing feature as an index by using the shared feature space feature for each of the plurality of training images and using a distance in the shared feature space based on distribution of the shared feature space features plotted in the shared feature space and the existing feature;
selecting as a base model, one of the trained models suitable for a purpose of training, on a basis of the index; and
performing retraining for the base model.
